(19) United States
(12) Patent Application Publication
(10) Pub. No.: US 2025/0311016 A1
(43) Pub. Date: Oct. 2, 2025

(54) PROXY ENTERPRISE CELLULAR ACCESS NETWORK VISIBILITY

(71) Applicant: Cisco Technology, Inc., San Jose, CA (US)

(72) Inventors: Timothy Peter Stammers, Raleigh, NC (US); Srinath Gundavelli, San Jose, CA (US)

(21) Appl. No.: 18/617,205

(22) Filed: Mar. 26, 2024

(51) Int. Cl. H04W 76/10; H04W 12/06; H04W 24/06

(52) U.S. Cl. CPC H04W 76/10; H04W 12/06; H04W 24/06

(57) ABSTRACT

A proxy service performing methods for representing a first type of access network as a second type of access network for visibility and management. The methods involve obtaining information about an endpoint device that established a connection to a first access network of an enterprise and generating a logical connection to a logical second access network based on a mapping of the information about the endpoint device with a profile associated with a second access network. The logical second access network represents the first access network as the second access network of the enterprise that is a different type of network. The methods further involve providing, to a network management service, the logical connection for observability and management of the first access network.

### TECHNICAL FIELD

The present disclosure generally relates to various communication technologies.

### BACKGROUND

Communication networks have grown substantially as end users have become increasingly connected to network environments. To handle increasing traffic from user equipment (UE), enterprises may deploy various access technologies to provide enterprise services. For example, enterprises may deploy private cellular access networks in addition to a WiFi® wireless local area network (WLAN), referred to as “WiFi”. Private cellular access networks may use 4th generation (4G) private Long Term Evolution (LTE) technology and/or 5th generation (5G) technology. Enterprise network architectures that use multiple network access types increase complexity and present challenges for network management.

### BRIEF DESCRIPTION OF THE DRAWINGS

FIG. 1 is a block diagram illustrating an environment in which a control center cloud provides visibility to private cellular access networks for purposes of management and observability, according to an example embodiment.

FIG. 2 is a block diagram illustrating an environment in which a data session established in a private cellular access network of an enterprise is emulated as a data session established in a WiFi network, according to an example embodiment.

FIGS. 3A-3F are sequence diagrams illustrating a method of representing a private cellular access network as a WiFi network for observability and network management, according to an example embodiment.

FIG. 4 is a flowchart of a method for generating and providing a logical second access network for observability and management of the first access network, according to an example embodiment.

FIG. 5 is a hardware block diagram of a computing device that may perform functions associated with any combination of operations in connection with the techniques depicted and described in FIGS. 1-4, according to various example embodiments.

### DETAILED DESCRIPTION

### Overview

Techniques presented herein provide a proxy service for representing a first type of access network as a second type of access network for visibility and management.

In one form, the method involves obtaining information about an endpoint device that established a connection with a first access network of an enterprise and generating a logical connection to a logical second access network based on a mapping of the information about the endpoint device with a profile associated with a second access network. The logical second access network represents the first access network as the second access network of the enterprise that is a different type of network. The methods further involve providing, to a network management service, the logical connection for observability and management of the first access network.

### Example Embodiments

Currently, enterprises can deploy private cellular access networks, which creates yet another network type for enterprise information technology (IT) team to learn and manage. It would be beneficial for these private cellular access networks to integrate with existing network management and observability systems that are in place for cabled and WiFi networks.

One way to achieve this integration is an application programming interface (API) level integration between the cellular access network service and existing capabilities such as a cloud-based network management platform. For example, API gap analysis can be performed, an agreement on the differences is achieved, and development is performed to address the gaps. Further, mapping of parameters and identities within APIs are performed to represent the private cellular access network. One challenge to such gap analysis, development to address the gaps, or acceptance of reduced capabilities of the enterprise operations, is that an enterprise's site reliability engineers (SREs) have to become familiar with cellular terminologies and develop skills to manage another different type of access network.

Another challenge with having multiple different access networks is authentication. Different access networks have different authentication techniques, typically referred to as “primary authentication”. In addition to an access network authentication, typically users authenticate onto another network e.g., private data network or an enterprise network. Authentication for an enterprise network is typically referred to as “secondary authentication”. While there may be approaches for a secondary authentication and authorization of client data sessions, there is no widespread support in clients for these approaches and these approaches entail additional capabilities in the private cellular packet core component to support enterprise-friendly authentication methods.

Related solutions to such issues do not address the problem of minimizing the operational disruption of learning new technology in the context of enterprise observability and management. For example, for solutions in which enterprise operational staff develop expertise in cellular terminologies, there is the accompanying risk that comes with a new integration. This incurs cost and is a hindrance to adoption of private cellular technologies by enterprises.

The techniques presented herein provide for representing a cellular client as if it is an enterprise WiFi client for management and observability. The techniques presented herein provide for a private cellular enterprise network to appear to be an instance of another type of access network. The techniques presented herein may not use any APIs, nor require special expertise by the enterprise IT team.

Specifically, the techniques presented herein integrate the private cellular access network of an enterprise into network management services/platform without special human expertise or APIs. The techniques presented herein manage private cellular access network of an enterprise by providing a consolidate view of WiFi and private cellular networks where an enterprise solution for WiFi network visibility and assurance is already deployed. The techniques presented herein provide for mapping an authentication of different access networks, an established data session of different access networks, and/or performance parameters in an established data session.

As such, the techniques presented herein may address at least some of the hindrances noted above by having a private cellular network, for example, appear to be an instance of a newly deployed additional WiFi access network. Cellular clients can appear as WiFi clients using the authentication procedures familiar in existing WiFi networks. Accordingly, the added private cellular access networks and associated clients can use the same mechanisms for management, observability, and assurance as the existing WiFi networks. The techniques presented herein may reduce costs and avoid errors in adopting and managing private cellular technologies.

Moreover, the techniques presented herein provide a system that obtains information about a private cellular access network of an enterprise including endpoint clients or endpoint devices that are using the private cellular access network and represents this network and endpoint devices as a WiFi network of the enterprise with WiFi endpoints for the purposes of management and observability. Based on information about an endpoint device that established a connection to a first access network of an enterprise, a logical connection of a logical second access network is generated by mapping of this information with a profile associated with a second access network. The logical second access network represents the first access network as the second access network of the enterprise that is a different type of network and the logical connection is provided to a network management service for observability and management of the first access network.

While one or more example embodiments are described with reference to a WiFi radio access system/network and a private cellular access system/network, one of ordinary skill in the art would readily appreciate that example embodiments are applicable to other access systems/networks now known or hereinafter developed.

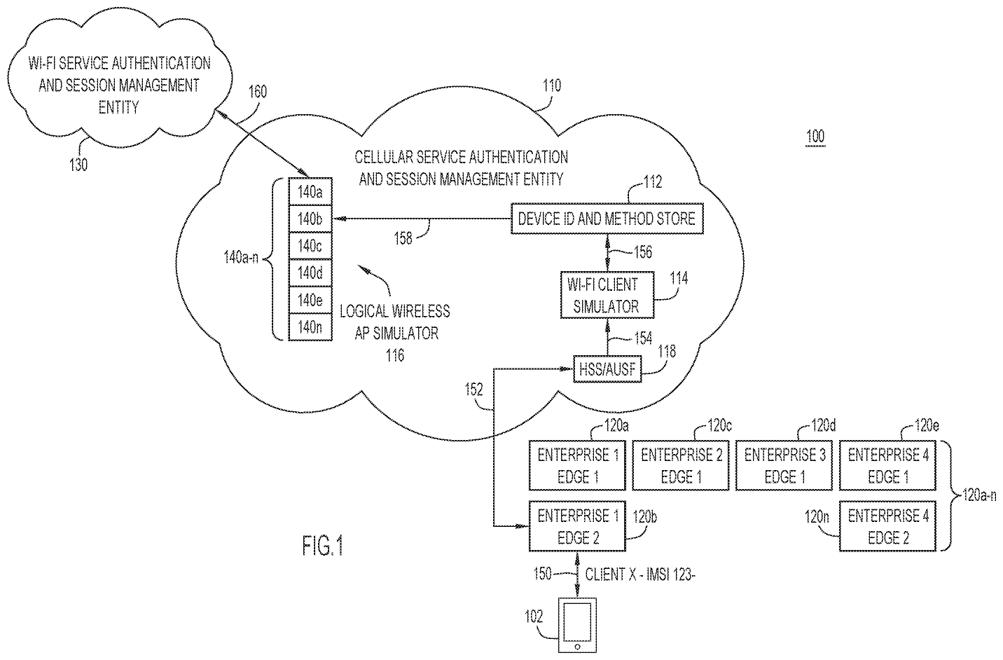

FIG. 1 is a diagram illustrating an environment 100 in which a cellular service authentication and session management entity 110 provides visibility to private cellular access networks for purposes of management and observability, according to an example embodiment. The environment 100 includes an endpoint device 102, the cellular service authentication and session management entity 110, private cellular access networks represented by private cellular access network nodes 120a-n, and a WiFi service authentication and session management entity 130.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

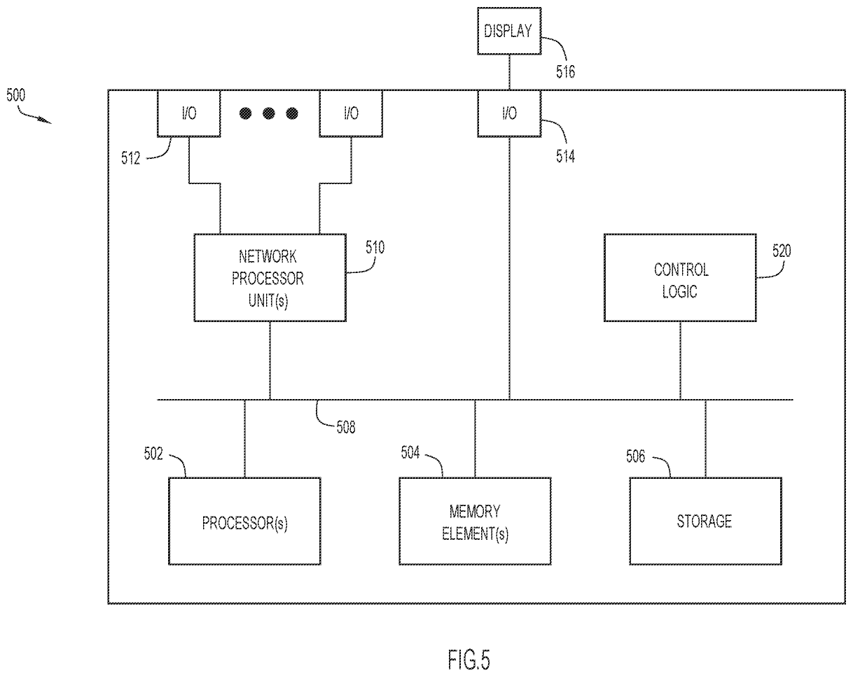

The endpoint device 102 may be a user equipment such as a smartphone, notepad, a notebook, a personal computer, etc. In various example embodiments, the endpoint device 102 may include a network interface, at least one processor, and a memory. The endpoint device 102 may be an apparatus or any programmable electronic or computing device capable of executing computer readable program instructions. The network interface may include one or more network interface cards (having one or more ports) that enable components of the entity to send and receive packets or data over network(s) such as a local area network (LAN) or a wide area network (WAN), and/or wireless access networks. The endpoint device 102 may include internal and external hardware components such as those depicted and described in further detail in FIG. 5. For example, the endpoint device 102 may include a Subscriber Identity Module (SIM) and/or eSIM that stores an international mobile subscriber identity (IMSI), as a device identifier (ID).

While only the endpoint device 102 is shown in FIG. 1, one of ordinary skill in the art would readily appreciate that multiple endpoint devices may be serviced by one or more private cellular access networks. In one example, at least some of these endpoint devices may be embodied as virtual devices with functionality distributed over a number of hardware devices, such as servers, etc. For example, some of the computational workload may be performed in a cloud.

The cellular service authentication and session management entity 110 is configured to perform private cellular service authentication and/or profile and session management. The cellular service authentication and session management entity 110 is configured to generate a logical connection of a logical second access network based on a mapping of information about the endpoint device 102 with a profile associated with a second access network. The logical second access network represents the first access network as the second access network of the enterprise that is a different type of network. In the logical second access network, multiple logical entities emulate physical entities of the first access network.

Specifically, the cellular service authentication and session management entity 110 includes a device ID and method store 112 (e.g. a memory or a database), a WiFi client simulator 114, a logical wireless AP simulator 116, and a home subscriber service (HSS) in fourth generation cellular architecture (e.g., Long Term Evolution (LTE) networks) or an authentication service function (AUSF) along with unified data management (UDM) of a fifth generation cellular architecture (5G), represented as HSS/AUSF 118 in FIG. 1.

The device ID and method store 112 is a database or a data store that is populated with enterprise identities (device identifiers “ID”) and respective authentication methods. For example, the device ID and method store 112 may store, for an enterprise 1, a directory entry such as user1@enterprise1.com. There is a profile associated with this user 1 that identifies the secure material or method i.e., a certificate used to authenticate the user. This secure material is used to authenticate for WiFi access. An identifier of the endpoint device 102 may be IMSI that is mapped to a secure material or a certificate for authenticating to a WiFi network. To authenticate onto a WiFi network, an open roaming authentication may be used. The secure material may include an extensible authentication protocol (EAP) certificate, EAP-SIM authentication (encryption keys), an EAP-tunneled transport layer security (EAP-TTLS) certificate, EAP-TLS certificate, a protected extensible authentication protocol (PEAP) key certificate, etc. In one or more example embodiments, the device ID and method store 112 stores a mapping of a device identifier that is registered with the enterprise and is associated with a profile including one or more authentication methods for authenticating to a second access network (e.g., WiFi) and another identifier for authenticating onto the second access network e.g., a service set identifier (SSID).

The WiFi client simulator 114 generates a logical user device that is connected to a second access network (e.g., WiFi network). The logical user device emulates the endpoint device 102 of a first access network (e.g., the private cellular access network). Additionally, the WiFi client simulator 114 may obtain first performance parameters of the endpoint device 102 in the first access network and generate second performance parameters associated with the logical user device in the second access network that represent the first performance parameters.

In one or more example embodiments, the WiFi client simulator 114 may be software that is configured to behave, emulate, or simulate a WiFi client. The WiFi client simulator 114 may perform an authentication, authorization, session management of a logical user device. The WiFi client simulator 114 may also provide information (transmission parameters, performance characteristics, etc.) of the logical user device (“WiFi client”) such as signal strength. This information or performance parameters may be used for observability/assurance. The performance parameters are generated based on data derived from various elements in a private cellular network e.g., from the endpoint device 102 such as Key Performance indicators (KPIs), statistics, packet core information, transport details, telemetry data, etc.

The logical wireless AP simulator 116 is configured to generate a logical access point for each edge of an enterprise cellular access network. The logical wireless AP simulator 116 generates a logical access point of a second access network (WiFi network) that emulates an edge instance of the first access network (private cellular access network), for authentication, authorization and/or session management.

In one or more example embodiments, the logical wireless AP simulator 116 may be software that represents each instance (e.g., edge) of an enterprise private cellular network as a WiFi AP for the purposes of an authentication, authorization, and session management. The WiFi AP is a logical construct that represents a single enterprise location of a private cellular access network deployment (enterprise edge) such as logical APs 140a-n. The logical wireless AP simulator 116 may obtain from the device ID and method store 112, a media access control (MAC) address that represents the endpoint device 102 and use this MAC address to perform WiFi service authentication and/or session management with the WiFi service authentication and session management entity 130.

For example, the logical APs 140a-n correspond to and represent private cellular access network nodes 120a-n. The private cellular access network nodes 120a-n include instances or edges of a first enterprise network (enterprise 1) such as a first edge 120a (represented by a first logical AP 140a such as “E1-E1”) and a second edge 120b (represented by a second logical AP 140b such as “E1-E2”), one instance (a third edge 120c) of a second enterprise network (enterprise 2) that is represented by a third logical AP 140c (e.gg., “E2-E1”), one instance (a fourth edge 120d) of a third enterprise network (enterprise 3) that is represented by a fourth logical AP 140d such as “E3-E1”), and two instances (a fifth edge 120e and a sixth edge 120n) of a fourth enterprise network (enterprise 4) that is represented by a fifth logical AP 140e and a sixth logical AP 140n, respectively such as “E4-E1” and “E4-E2”). This is provided by way of a non-limiting example and not by way of a limitation.

The HSS/AUSF 118 is configured to verify subscriber's identity, validate subscription data, and/or determine security context for the subscriber/user i.e., the endpoint device 102. In other words, the HSS/AUSF 118 is configured to authenticate the endpoint device 102 onto the private cellular access network.

The WiFi service authentication and session management entity 130 is a management entity such as a cloud platform or a set of tools that allows for management and control of WiFi networks. For example, using the WiFi service authentication and session management entity 130, a user may view real-time performance of an AP (traffic visibility), reconfigure an AP (traffic optimization), obtain network topology, etc. By way of an example, the WiFi service authentication and session management entity 130 may depict, via a dashboard or a user interface screen, real-time traffic in an enterprise WiFi network e.g., layer 7 traffic visibility. Using the WiFi service authentication and session management entity 130, a user may configure rules such that a particular AP is favored for a particular type or class of traffic or that based on a quality of service (QOS), a different AP is to be used. Additionally, the WiFi service authentication and session management entity 130 may be used to upgrade firmware of the APs, reconfigure the APs (add a security protocol, etc.). As another example, the WiFi service authentication and session management entity 130 may request execution of traffic and connectivity tests and/or display session and client details and/or access network details related to the session.

In the environment 100, when the endpoint device 102 authenticates onto the a private cellular access network, a corresponding logical WiFi client device is generated and authenticated to the WiFi service authentication and session management entity 130 for observability and management.

Specifically, at 150, the endpoint device 102 attaches to a private cellular access network i.e., via the second edge 120b of the first enterprise network (E1, E2), and provides its unique identifier e.g., IMSI 123 . . . .

At 152, via the second edge 120b, using the unique identifier, the HSS/AUSF 118 may authenticate the endpoint device 102 onto the private cellular access network of the first enterprise. Additionally, the HSS/AUSF 118 provides a profile for the endpoint device 102 to the second edge 120b and establishes a cellular session via the second edge 120b for the endpoint device 102.

Meanwhile, at 154, the HSS/AUSF 118 also provides the WiFi client simulator 114 with first information about endpoint device 102 that has been authenticated onto the private cellular access network. First information includes a device identifier (e.g., IMSI 123 . . . ), user or subscriber profile, and an identity of the second edge 120b (e.g., second edge of the first enterprise).

At 156, the WiFi client simulator 114 communicates with the device ID and method store 112 to obtain second information for the WiFi network (e.g., a second access network of the enterprise). For example, the WiFi client simulator 114 provides the first information. In response thereto and based on the first information e.g., the identity of the endpoint device 102 (IMSI), the device ID and method store 112 may provide a matching device identifier for the second access network (SSID) and an authentication method such as an EAP-TLS, EAP-SIM, EAP-Protected Extensible Authentication Protocol (PEAP), or EAP-TTLS (using authentication certificates and/or EAP-TTLS secure information). That is, the device ID and method store 112 provides certificates that can be used to represent and authenticate a user in a second access network (WiFi network).

At 158, the WiFi client simulator 114 uses the second information to authenticate the endpoint device 102 (a logical user device) onto the enterprise network via a logical access point (AP). The second logical AP 140b is the logical AP that corresponds to second edge 120b.

At 160, the second logical AP 140b may use OpenRoaming authentication techniques to authenticate the logical user device onto the WiFi network i.e., the WiFi service authentication and session management entity 130. In other words, a simulator of a WiFi client authenticates to the enterprise network via a logical WiFi AP using e.g., OpenRoaming techniques. This allows a cloud hosted service to authenticate to the correct enterprise, by domain, that “owns” the user associated with the logical WiFi client. The WiFi AP is a logical construct within the control center cloud that represents a single enterprise location private cellular access network deployment (an enterprise edge).

An enterprise authorizes the private cellular service to issue a certificate representing the user. This certificate is associated with the IMSI assigned to that user and stored in the cellular service. The enterprise knows the relationship of that certificate to the user and hence can link the state established at 152 with an existing state for the same user. Subsequent establishing a data session on a cellular network results in establishing an emulated session as a WiFi session.

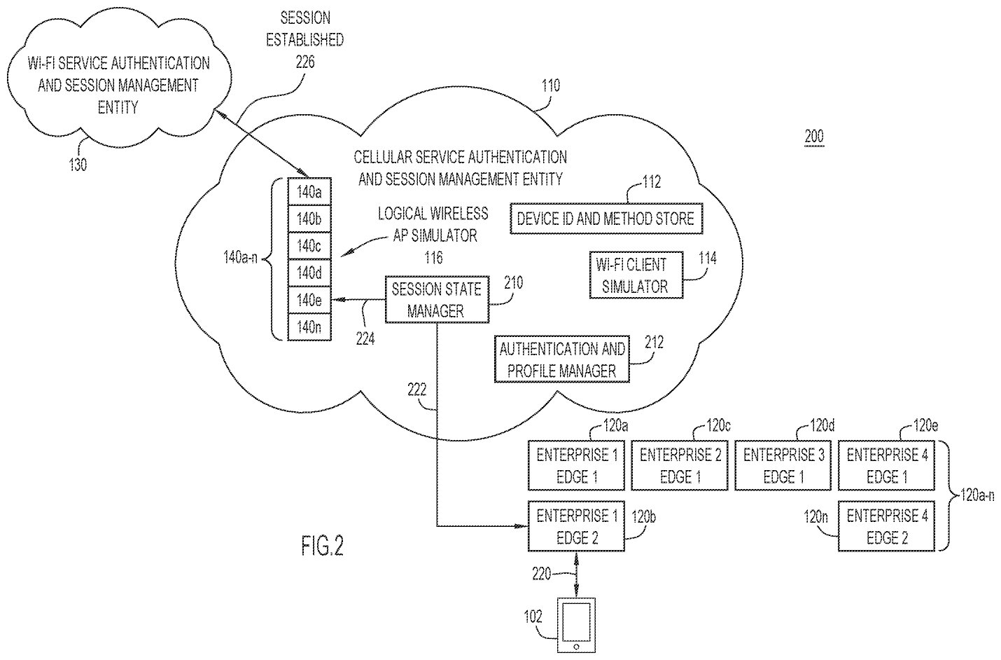

With continued reference to FIG. 1, FIG. 2 is a block diagram illustrating an environment 200 in which a data session established in a private cellular access network of an enterprise is emulated as a data session established in a WiFi network, according to an example embodiment. The environment 200 involves the same entities as in FIG. 1 i.e., the endpoint device 102, the cellular service authentication and session management entity 110, the private cellular access network nodes 120a-n, and the WiFi service authentication and session management entity 130.

In the environment 200, the cellular service authentication and session management entity 110 includes a session state manager 210 and an authentication and profile manager 212 such as HSS/AUSF 118 of FIG. 1. The session state manager 210 may be an element management system (EMS) of a 4G or a 5G network that manages functions and capabilities of the endpoint device 102 in the cellular network. For example, the session state manager 210 may be a private cellular radio access network (RAN) EMS that knows the state of the data session of the endpoint device 102 and that learns parameters or characteristics of the established data session. For example, the session state manager 210 may learn signal strength, neighbor lists response times for access signals, quality of service (QOS) parameters, etc.

In the environment 200, the process of emulating a cellular data session as a WiFi data session starts at 220. Specifically, at 220, the endpoint device 102 establishes a cellular data session via a second edge 120b (after being authenticated as described in FIG. 1). At 222, the second edge 120b reports the state of the data session to the session state manager 210. For example, the second edge 120b may report that user X with the endpoint device 102 having IMSI 123 established a data session via the private cellular access network.

The logical WiFi AP (e.g., the second logical AP 140b) emulates the second edge 120b i.e., a physical radio access network node or entity local to the endpoint device 102. The second logical AP 140b may subscribe to events related to the endpoint devices attached to the second edge 120b i.e., physical radio access network nodes. The events may involve authentication related events, session related events, accounting events such as updates about data sessions. Based on being subscribed to network events, at 224, the second logical AP 140b obtains cellular access details for the IMSI 123 from the session state manager 21. As an example, cellular access details may be a cellular access state such as data session for a user X with the endpoint device 102 (IMSI 123) is established. Moreover, the second logical AP 140b learns signal strength, neighbor lists response times for access signaling. The second logical AP 140b then reports the cellular access details, and any other relevant available information dependent on RAN EMS capabilities, using the same mechanisms and formats as a “real” WiFi AP (i.e., as if it is a physical access point of a WiFi network).

At 226, the second logical AP 140b indicates to the WiFi service authentication and session management entity 130 that the user X with the endpoint device 102 (SSID “456”) established a data session. The logical AP 140b generates radius messaging as if a data session is being established in the logical WiFi network. In one or more example embodiments, the parameters may be translated from cellular type parameters to WiFi type parameters by the session state manager 210 and/or the second logical AP 140b.

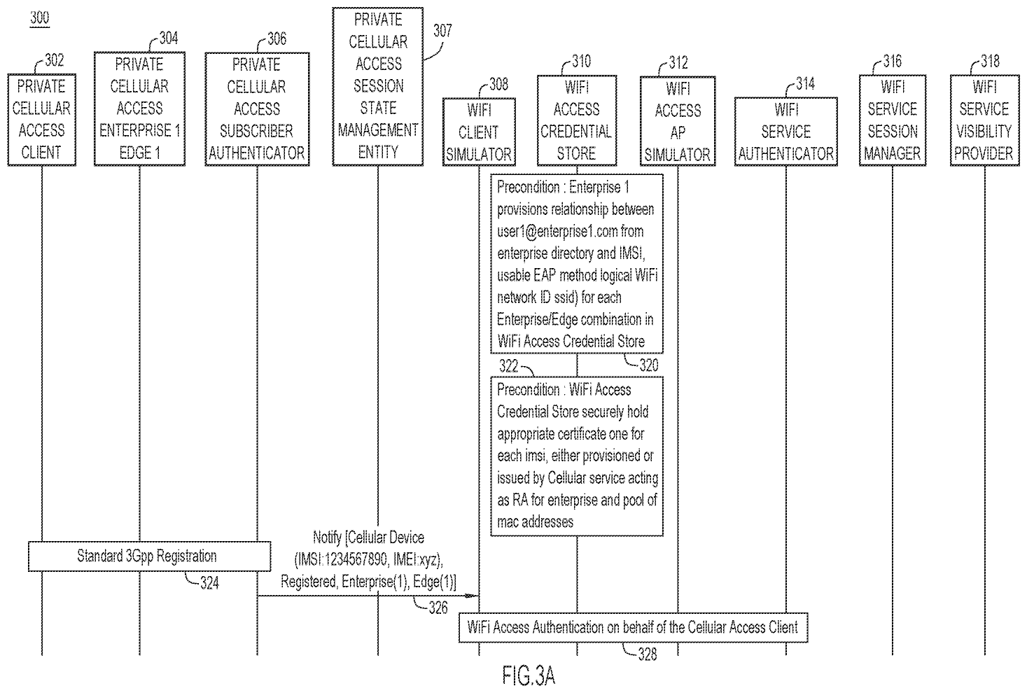

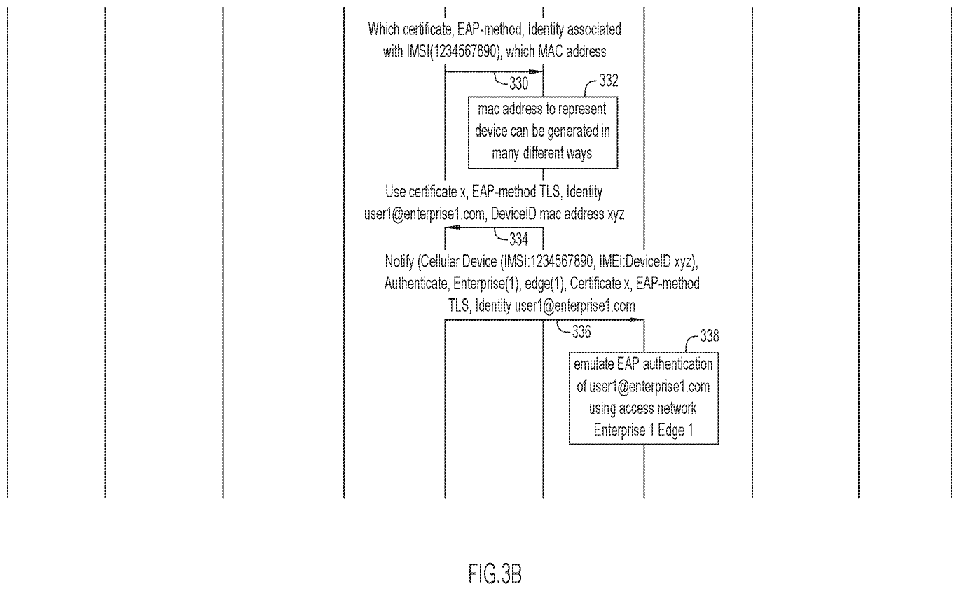

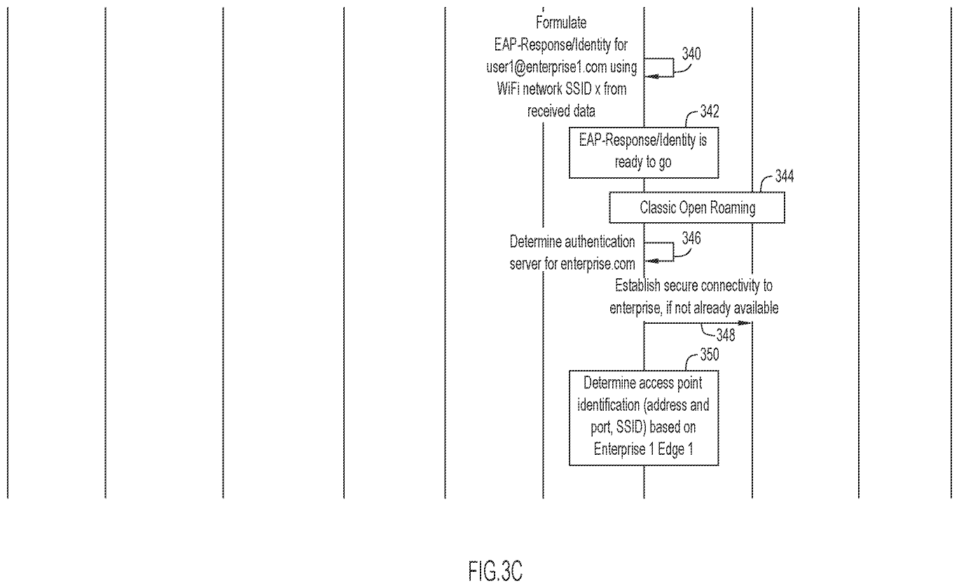

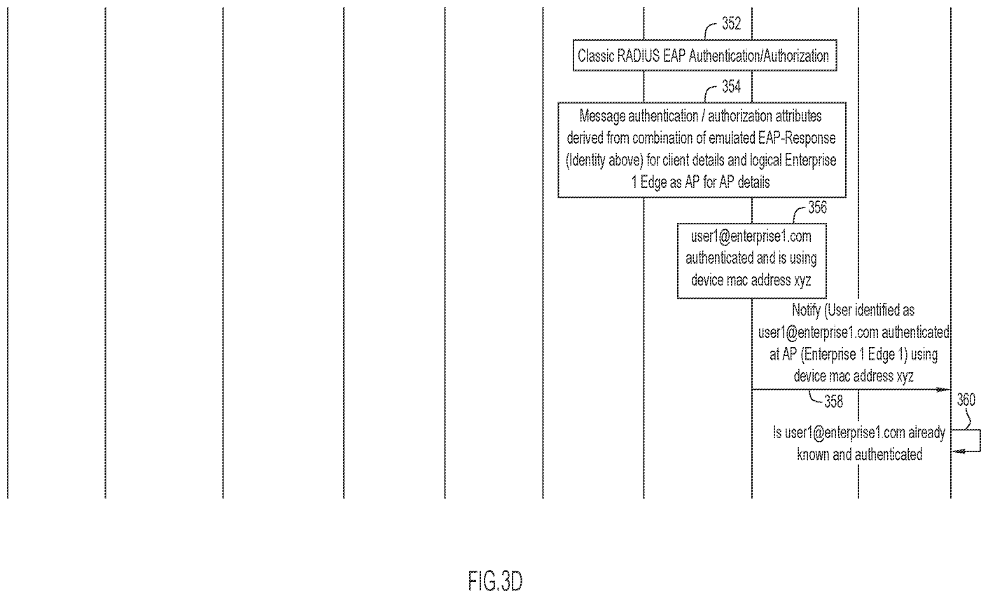

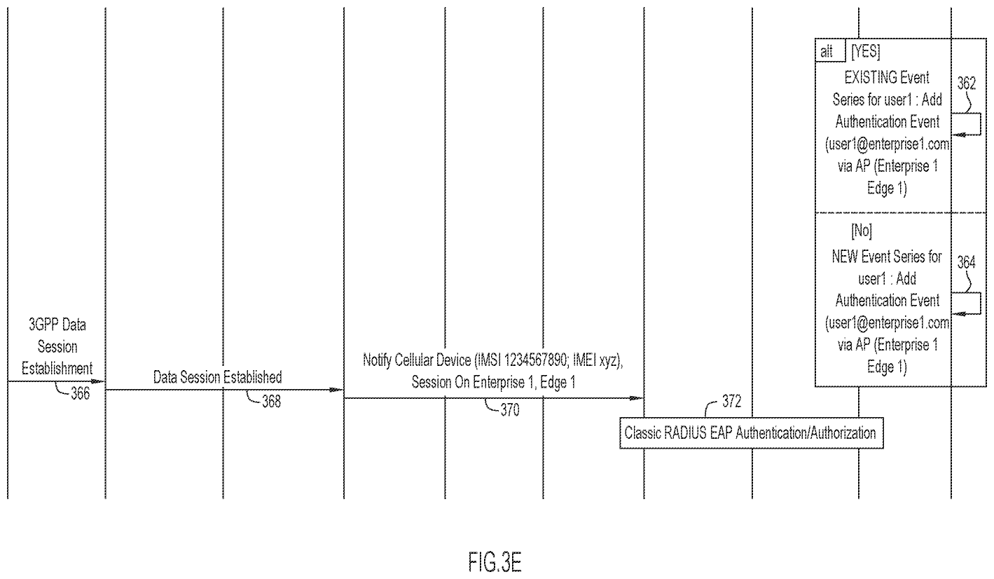

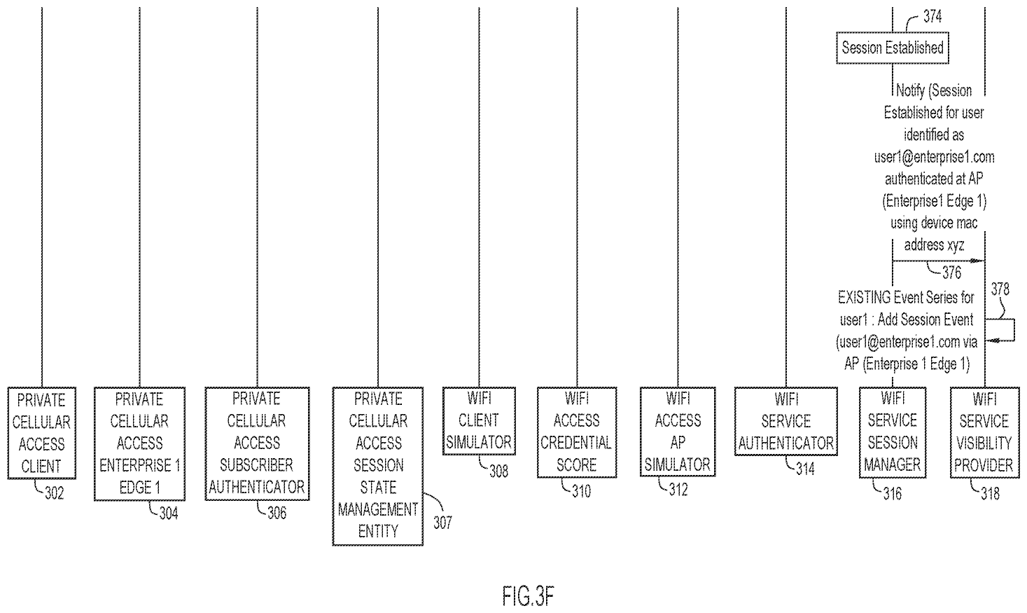

FIGS. 3A-3F are sequence diagrams illustrating a method 300 of representing a private cellular access network as a WiFi network for observability and network management, according to an example embodiment. The method 300 provides private cellular visibility as a WiFi access network.

The method 300 involves a private cellular access client 302 such as the endpoint device 102 of FIGS. 1 and 2, a private cellular access enterprise edge 304 such as the first edge 120a of FIGS. 1 and 2, a private cellular access authenticator 306 that is configured to perform subscriber authentication and manage profile for a user associated with the enterprise, and a private cellular access session state management entity 307 that manages established cellular data sessions of endpoint devices. These are just some non-limiting examples of physical radio access network entities.

The method 300 further involves a WiFi client simulator 308 such as WiFi client simulator 114 of FIGS. 1 and 2, a WiFi access credential store 310 such as device ID and method store 112 of FIGS. 1 and 2, and a WiFi access AP simulator 312 such as logical wireless AP simulator 116 of FIGS. 1 and 2. These are just some non-limiting examples of entities involved with generating logical wireless local access network entities that emulate the physical radio access network entities.

Additionally, the method 300 involves a WiFi service authenticator 314, a WiFi service session manager 316, and a WiFi service visibility provider 318, e.g., collectively WiFi service authentication and session management entity 130. These are just some non-limiting examples of physical wireless local access network entities.

The method 300 may involve initial provisioning i.e., preconditions. Specifically, at 320, the WiFi access credential store 310 is provisioned to store an association between an enterprise user and a profile. An enterprise may provision a relationship or link a user profile from an enterprise directory (e.g., user1@enterprise1.com) with device information or identifier (e.g., IMSI). The user profile may further include a WiFi authentication method and/or secure material. As an example, a first enterprise (E1) may have a directory entry for user1@enterprise1.com. This directory entry is associated with a user profile that identifies the secure material and/or method of authentication. For example, the user profile may include an EAP certificate for authenticating the user, a usable EAP method, and a logical WiFi network identifier (e.g., SSID) for each enterprise/edge combination in the WiFi access credential store 310. The secure material is then used to authenticate for WiFi access via the WiFi authentication method.

Additionally, the preconditions may include provisioning for cellular access. At 322, the WiFi access credential store 310 stores or securely holds an appropriate certificate for each IMSI. Each device identifier has a corresponding certificate for authenticating onto a cellular network. The certificate is provisioned or issued by a cellular service acting as a registration authority (RA) for the enterprise.

The WiFi access credential store 310 also stores a pool of media access control (MAC) addresses that may be assigned for simulation of WiFi network.

The method 300 starts at 324, in which the private cellular access client 302 performs standard 3GPP registration with the private cellular access authenticator 306. In other words, the private cellular access client 302 registers with the private cellular access authenticator 306.

At 326, the private cellular access authenticator 306 notifies the WiFi client simulator 308 that a cellular device (the private cellular access client 302) is registered with the cellular access service and is attached to a particular edge. For example, the private cellular access client 302 has a device identifier such as IMSI 1234567890 and an international mobile equipment identify (IMEI) xyz and is attached to private cellular access enterprise edge 304 (Edge 1 of Enterprise 1). This information is registered with the private cellular access authenticator 306 and provided to the WiFi client simulator 308.

At 328, the WiFi client simulator 308 performs WiFi access authentication on behalf of the private cellular access client 302 with the WiFi service authenticator 314.

The method 300 continues at FIG. 3B. Specifically, at 330, the WiFi client simulator 308 queries the WiFi access credential store 310 for a method of authentication for the WiFi network and a MAC address for the WiFi network. For example, the WiFi client simulator 308 provides the device identifier (IMSI 1234567890) and asks for EAP-method, an identity associated with the device identifier, and a MAC address to be used.

At 332, the WiFi access credential store 310 performs a lookup operation for the IMSI received from the WiFi client simulator 308 for an authentication method and user/subscriber profile. Additionally, the WiFi access credential store 310 may generate or select a MAC address to represent the private cellular access client 302.

At 334, the WiFi access credential store 310 provides, to the WiFi client simulator 308, information needed to authenticate a logical client device onto a WiFi network. For example, the WiFi access credential store 310 provides a certificate to use for authentication (e.g., certificate x), an authentication method EAP-method (e.g., TLS), subscriber profile (e.g., user1@enterprise1.com), a WiFi device identifier (e.g., selected MAC address xyz).

At 336, the WiFi client simulator 308 notifies the WiFi access AP simulator 312 that private cellular access client 302 was successfully authenticated onto a cellular access network i.e., the private cellular access enterprise edge 304 (enterprise 1, edge 1). The WiFi client simulator 308 may provide, to the WiFi access AP simulator 312, cellular access information, information about the enterprise edge being used, and WiFi access information. As an example, the cellular access information may include IMSI 1234567890, IMEI Device ID xyz (registered with the private cellular access authenticator 306). The information about the enterprise edge may indicate that the private cellular access client 302 is attached to enterprise 1, edge 1 i.e., the private cellular access enterprise edge 304. The WiFi access information may include certificate x, EAP method TLS, and subscriber identity (user1@enterprise1.com).

Based on the information at 336, at 338, the WiFi access AP simulator 312 emulates EAP authentication of the user (i.e., user1@enterprise1.com) using access network of a logical AP that corresponds to the private cellular access enterprise edge 304 (enterprise 1, edge 1). As such, the WiFi access AP simulator 312 has information for emulating authentication in a WiFi network.

The method 300 then continues at FIG. 3C. Specifically, at 340, the WiFi access AP simulator 312 generates or formulates EAP response/identity for the user (i.e., user1@enterprise1.com) using access network i.e., the logical AP that corresponds to private cellular access enterprise edge 304 (enterprise 1, edge 1). At 342, the EAP response/identity for the user (i.e., WiFi identity) is generated and at 344, the WiFi access AP simulator 312 performs classic open roaming with the WiFi service authenticator 314 to authenticate the emulated logical client device onto the WiFi access network. At 346, the WiFi access AP simulator 312 determines authentication server for the first enterprise (enterprise1.com) and at 348, the WiFi access AP simulator 312 establishes a secure connection with the WiFi service authenticator 314 (i.e., the determined authentication server). The operation 348 may be omitted, if the secure connection to the enterprise's authentication server has previously been established.

At 350, the WiFi access AP simulator 312 further determines access point identification information such as address and port SSID based on information about the enterprise edge being used e.g., enterprise 1, edge 1.

The method 300 proceeds at FIG. 3D. In FIG. 3D, at 352, the WiFi access AP simulator 312 performs classis remote authentication dial-in user service (RADIUS) EAP authentication and/or authorization with the WiFi service authenticator 314. At 354, the WiFi access AP simulator 312 and the WiFi service authenticator 314 message authentication/authorization attributes that may be derived from a combination of emulated EAP-Response (identity at 352) for client details and a logical first edge of a first enterprise as AP for AP details. At 356, the WiFi service authenticator 314 authenticates the subscriber onto a WiFi access network e.g., user1@enterprise1.com using device MAC address xyz.

At 358, the WiFi service authenticator 314 notifies the WiFi service visibility provider 318 that the user e.g., user1@enterprise1.com is authenticated at a logical AP i.e., WiFi AP (which represents first edge of a first enterprise such as the private cellular access enterprise edge 304) using the MAC address xyz.

At 360, the WiFi service visibility provider 318 determines whether the user (user1@enterprise1.com) is already known and been authenticated at the WiFi service visibility provider 318.

The method 300 continues at FIG. 3E. Specifically, in case the user is known, at 362, the WiFi service visibility provider 318 adds an authentication event to existing event series for the user (user1@enterprise1.com). The added event may be an authentication event for user1@enterprise1.com via a logical AP (enterprise 1, edge 1). In case the user is not yet known, at 364, the WiFi service visibility provider 318 generates a new event series and adds the authentication event as a new event for the user i.e., add authentication event for the user1@enterprise 1.com via the logical AP (enterprise 1, edge 1).

Additionally, in the method 300, when the private cellular access client 302 is authenticated onto the private cellular access network, at 366, the private cellular access client 302 establishes a data session via the private cellular access enterprise edge 304. For example, a standard 3GPP data session establishment procedure is performed. At 368, the private cellular access enterprise edge 304 provides a status update (session state) to the private cellular access session state management entity 307, which is configured to manage session states. Since the WiFi access AP simulator 312 is subscribed to events related to the private cellular access client 302, at 370, the WiFi access AP simulator 312 is notified that the data session for the private cellular access client 302 has been established. For example, the private cellular access session state management entity 307 notifies that cellular device (IMSI 1234567890, IMEI xyz) has a data session on the private cellular access enterprise edge 304 (enterprise 1, edge 1).

At 372, the WiFi access AP simulator 312 initiates classic RADIUS accounting with WiFi service session manager 316.

The method 300 continues at FIG. 3F. Specifically, at 374, the WiFi service session manager 316 establishes a logical WiFi session for the private cellular access client 302. At 376, the WiFi service session manager 316 notifies the WiFi service visibility provider 318 that data session is established for user1@enterprise1.com, which is authenticated at a logical WiFi AP (enterprise 1, edge 1) using a device MAC address xyz. At 378, the WiFi service visibility provider 318 adds the session state event to an existing event series for user1@enterprise1.com. For example, the event is a session event for user1@enterprise1.com via AP (enterprise 1, edge 1).

The techniques presented herein involve representing a cellular access network as a WiFi network. The techniques generate a logical AP representation of a cellular access network deployment. Cellular authentication credential are mapped to an enterprise authentication credential and store for use. The techniques further provide W-Fi client SIM building client-source observability and assurance data from a mixture of sources in a private cellular network of the enterprise. Enterprise with existing WiFi and cabled access networks are thus configured to also have visibility into a private cellular access networks. A logical WiFi access network is generated with associated user credentials, access points, authentication and session management procedures. As such, the private cellular access network is emulated as if it is a WiFi access network, giving visibility with no changes to existing enterprise systems. The techniques presented herein provide for logical APs to report various aspects of access network behavior to enterprise management services for visibility and assurance.

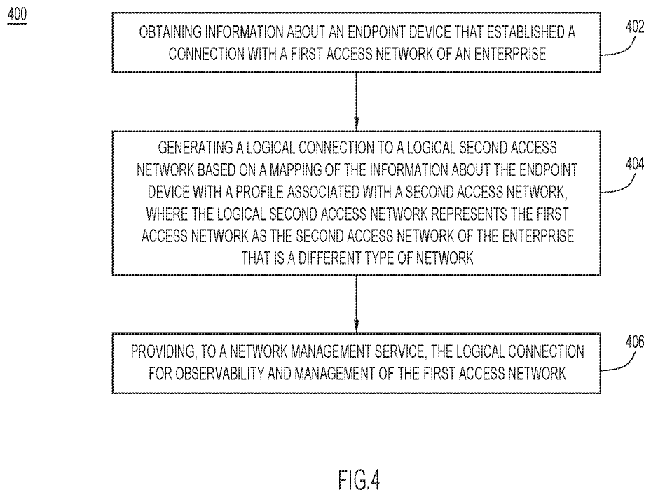

FIG. 4 is a flowchart illustrating a computer-implemented method 400 of providing a generated logical second access network that represents a first access network, according to an example embodiment. The computer-implemented method 400 may be performed by one or more computing devices or an apparatus. For example, the computer-implemented method 400 may be performed by the cellular service authentication and session management entity 110 of FIG. 1 or 2 or one or more of the following entities of FIG. 3: private cellular access authenticator 306, private cellular access session state management entity 307, WiFi client simulator 308, WiFi access credential store 310, WiFi access AP simulator 312, WiFi service authenticator 314, or WiFi service session manager 316.

The computer-implemented method 400 involves at 402, obtaining information about an endpoint device that established a connection with a first access network of an enterprise.

The computer-implemented method 400 further involves at 404, generating a logical connection to a logical second access network based on a mapping of the information about the endpoint device with a profile associated with a second access network. The logical second access network represents the first access network as the second access network of the enterprise that is a different type of network.

The computer-implemented method 400 further involves at 406, providing, to a network management service, the logical connection for observability and management of the first access network.

In one instance, in the computer-implemented method 400, the first access network may be a private cellular access network and the second access network may be a wireless local access network.

According to one or more example embodiments, a plurality of simulation entities in the logical second access network may emulate a plurality of physical entities in the first access network.

In one form, the operation 402 of obtaining the information about the endpoint device may involve obtaining a device identifier of the endpoint device that is authenticated onto the first access network.

According to one or more example embodiments, in the computer-implemented method 400, the mapping may include the device identifier being registered with the enterprise and being associated with the profile including one or more authentication methods for the second access network and another identifier for authenticating onto the second access network.

In another form, the operation 404 of generating the logical connection to the logical second access network may further include generating a logical access point of the second access network that emulates an edge instance of the first access network, for an authentication, an authorization and/or session management.

According to one or more example embodiments, the operation 404 of generating the logical connection to the logical second access network may further include generating a logical user device that is connected to the second access network and that emulates the endpoint device of the first access network.

In one instance, the computer-implemented method 400 may further include obtaining first performance parameters of the endpoint device in the first access network and generating second performance parameters associated with the logical user device in the second access network based on the first performance parameters.

In another instance, the computer-implemented method 400 may further include authenticating, by the logical user device via the logical access point, onto an enterprise network using an open roaming authentication and based on a media access control address generated for the logical user device. Open roaming authentication is just one example, and other authentication techniques are within the score of this disclosure.

FIG. 5 is a hardware block diagram of a computing device 500 that may perform functions associated with any combination of operations in connection with the techniques depicted in FIGS. 1-4, according to various example embodiments, including, but not limited to, operations of one or more entities of FIGS. 1-3 such as the endpoint device 102, component(s) of the cellular service authentication and session management entity 110, private cellular access network nodes 120a-n, and/or the WiFi service authentication and session management entity 130 of FIG. 1 or 2, the private cellular access client 302, the private cellular access enterprise edge 304, the private cellular access authenticator 306, the WiFi client simulator 308, the WiFi access credential store 310, the WiFi access AP simulator 312, the WiFi service authenticator 314, the WiFi service session manager 316, and/or the WiFi service visibility provider 318 of FIG. 3. It should be appreciated that FIG. 5 provides only an illustration of one example embodiment and does not imply any limitations with regard to the environments in which different example embodiments may be implemented. Many modifications to the depicted environment may be made.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with one or more memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 516, a display screen (touch screen on a mobile device), or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory and a network interface configured to enable network communications. The apparatus further includes a processor. In this apparatus, the processor is configured to perform a method, which includes obtaining information about an endpoint device that established a connection with a first access network of an enterprise and generating a logical connection to a logical second access network based on a mapping of the information about the endpoint device with a profile associated with a second access network. The logical second access network represents the first access network as the second access network of the enterprise that is a different type of network. The method further includes providing, to a network management service, the logical connection for observability and management of the first access network.

In yet another example embodiment, one or more non-transitory computer readable storage media encoded with instructions are provided. When the media is executed by a processor, the instructions cause the processor to execute a method that involves obtaining information about an endpoint device that established a connection with a first access network of an enterprise and generating a logical connection to a logical second access network based on a mapping of the information about the endpoint device with a profile associated with a second access network. The logical second access network represents the first access network as the second access network of the enterprise that is a different type of network. The method further includes providing, to a network management service, the logical connection for observability and management of the first access network.

In yet another example embodiment, a system is provided that includes the devices and operations explained above with reference to FIGS. 1-5.

The programs described herein (e.g., control logic 520) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 506 and/or memory elements(s) 504 can store data, software, code, instructions (e.g., processor instructions), logic, parameters, combinations thereof, and/or the like used for operations described herein. This includes the storage 506 and/or memory elements(s) 504 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., WiFi®/WiFi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining information about an endpoint device that established a connection to a first access network of an enterprise;
generating a logical connection to a logical second access network based on a mapping of the information about the endpoint device with a profile associated with a second access network, wherein the logical second access network represents the first access network as the second access network of the enterprise that is a different type of network; and
providing, to a network management service, the logical connection for observability and management of the first access network.

2. The computer-implemented method of claim 1, wherein the first access network is a private cellular access network and the second access network is a wireless local access network.

3. The computer-implemented method of claim 2, wherein a plurality of simulation entities in the logical second access network emulate a plurality of physical entities in the first access network.

4. The computer-implemented method of claim 1, wherein obtaining the information about the endpoint device includes:
obtaining a device identifier of the endpoint device that is authenticated onto the first access network.

5. The computer-implemented method of claim 4, wherein the mapping includes the device identifier being registered with the enterprise and being associated with the profile including one or more authentication methods for the second access network and another identifier for authenticating onto the second access network.

6. The computer-implemented method of claim 1, wherein generating the logical connection to the logical second access network further includes:
generating a logical access point of the second access network that emulates an edge instance of the first access network, for an authentication, an authorization and/or session management.

7. The computer-implemented method of claim 6, wherein generating the logical connection to the logical second access network further includes:
generating a logical user device that is connected to the logical second access network and that emulates the endpoint device of the first access network.

8. The computer-implemented method of claim 7, further comprising:
obtaining first performance parameters of the endpoint device in the first access network; and
generating second performance parameters associated with the logical user device in the second access network based on the first performance parameters.

9. The computer-implemented method of claim 7, further comprising:
authenticating, by the logical user device via the logical access point, onto an enterprise network using an open roaming authentication and based on a media access control address generated for the logical user device.

10. An apparatus comprising:
a memory;
a network interface configured to enable network communications; and
a processor, wherein the processor is configured to perform a method comprising:
obtaining information about an endpoint device that established a connection to a first access network of an enterprise;
generating a logical connection to a logical second access network based on a mapping of the information about the endpoint device with a profile associated with a second access network, wherein the logical second access network represents the first access network as the second access network of the enterprise that is a different type of network; and
providing, to a network management service, the logical connection for observability and management of the first access network.

11. The apparatus of claim 10, wherein the first access network is a private cellular access network and the second access network is a wireless local access network.

12. The apparatus of claim 11, wherein a plurality of simulation entities in the logical second access network emulate a plurality of physical entities in the first access network.

13. The apparatus of claim 10, wherein the processor is configured to obtain the information about the endpoint device by:
obtaining a device identifier of the endpoint device that is authenticated onto the first access network.

14. The apparatus of claim 13, wherein the mapping includes the device identifier being registered with the enterprise and being associated with the profile including one or more authentication methods for the second access network and another identifier for authenticating onto the second access network.

15. The apparatus of claim 10, wherein the processor is configured to generate the logical connection to the logical second access network further by:
generating a logical access point of the second access network that emulates an edge instance of the first access network, for an authentication, an authorization and/or session management.

16. The apparatus of claim 15, wherein the processor is further configured to generate the logical connection to the logical second access network further by:
generating a logical user device that is connected to the second access network and that emulates the endpoint device of the first access network.

17. One or more non-transitory computer readable storage media encoded with software comprising computer executable instructions that, when executed by a processor, cause the processor to perform a method including:
obtaining information about an endpoint device that established a connection to a first access network of an enterprise;
generating a logical connection to a logical second access network based on a mapping of the information about the endpoint device with a profile associated with a second access network, wherein the logical second access network represents the first access network as the second access network of the enterprise that is a different type of network; and
providing, to a network management service, the logical connection for observability and management of the first access network.

18. The one or more non-transitory computer readable storage media according to claim 17, wherein the first access network is a private cellular access network and the second access network is a wireless local access network.

19. The one or more non-transitory computer readable storage media according to claim 18, wherein a plurality of simulation entities in the logical second access network emulate a plurality of physical entities in the first access network.

20. The one or more non-transitory computer readable storage media according to claim 17, wherein the computer executable instructions cause the processor to obtain the information about the endpoint device by:
obtaining a device identifier of the endpoint device that is authenticated onto the first access network.
